(19) United States
(12) Patent Application Publication
(10) Pub. No.: US 2021/0325839 A1
(43) Pub. Date: Oct. 21, 2021

(54) METHODS OF ESTIMATING OCCUPANCY ENERGY PROFILE FOR BUILDING ENERGY MANAGEMENT AND SPACE OPTIMIZATION

(71) Applicant: SIGNIFY HOLDING B.V., Eindhoven (NL)

(72) Inventors: JIA HU, BROOKLINE, MA (US); CHANG LIU, OSSINING, NY (US)

(21) Appl. No.: 16/334,607

(22) PCT Filed: Sep. 19, 2017
(86) PCT No.: PCT/EP2017/073637

§ 371 Date: Mar. 19, 2019

Related U.S. Application Data
(60) Provisional application No. 62/398,914, filed on Sep. 23, 2016.

(30) Foreign Application Priority Data
Oct. 11, 2016 (EP) 16193309.8

(51) Int. Cl. G05B 19/042

(52) U.S. Cl. CPC G05B 19/042; G05B 2219/2639

(57) ABSTRACT

Inventive methods and apparatus are disclosed for obtaining an Occupancy Energy Profile (OEP) for at least one occupant of one or more rooms in a building. OEPs can be collected and used for various energy management functions for the building to include scheduling of meeting rooms, lighting and HVAC optimization, and maintenance functions.

### FIELD OF THE INVENTION

The present invention is directed to Inventive methods and system for estimating occupancy energy profiles of individuals and utilizing this information in building energy management functions.

### BACKGROUND OF THE INVENTION

Wearable sensor systems provide real-time feedback that enables a wide range of new preventive-health, security and fitness. For example, a fitness tracker monitors personal activity, energy consumption, heart rate, etc. A doctor or fitness coach can extract personal health information from the daily monitoring data. Similarly, in a building system, better building energy management is improved if energy consumption of a building is broken down to each individual occupant, who is the most dynamic factor inside the building.

As used herein, an occupancy energy profile (OEP) is defined as energy consumption profile of each occupant in a building. That is, this metric can track how energy is consumed by the individual occupant in a real-time system. It has many applications. For example, an occupant can be analyzed with respect to time/energy costs related to his laptop usage, or to monitor his attendance in meeting rooms or zones of a building. Similar to the information offered by a fitness tracker, better behavior management can be employed. That is, the facility managers can evaluate the space utilization and optimize meeting room usage based on occupancy behavior and energy usage in each room. In addition, the information can also help to forecast building energy, which is a function of building characteristics, control and maintenance, weather parameters, and occupants' behavior. By integrating the occupancy energy profile, an occupancy behavior pattern can be determined and a fine-grain building energy forecasting model can be developed.

### SUMMARY OF THE INVENTION

Given all the potential useful applications of an OEP, the question is how to accurately estimate it. Currently, no accurate way of measuring this information exists. The most common and simple approach used is to calculate the average energy consumption per occupant by dividing the total energy consumption by the number of occupants. This method does not distinguish individual behavior of occupants for various reasons—to include the difficulty in tracking occupancy.

The popularity of wearable sensors, smart meters and visible light communication (VLC) technology makes it possible to provide more accurate occupancy energy data. In this invention, we developed a system and method of monitoring and calculating OEPs from this data and applying these OEPs to building energy management services.

Typically building energy management systems rely on meters and sensors to provide suggestions of space usage, building control and maintenance. Occupancy is one of the most important dynamic factors inside a building. However, occupancy information is not fully explored in existing building energy management systems because of the difficulty and challenges in occupancy tracking and people counting. Some of the problems for current occupancy monitoring and energy management systems are:
The current method of calculating energy consumption per user is to simply divide the total energy by the number of building occupants. There is no accurate method of calculating occupancy energy profile for individuals by using this simple method in real-time.
The space utilization and meeting room scheduling is mainly based on the availability. Preferably, facility managers should also consider energy usage of the space to reduce energy consumption.
The current building energy estimation is based on historical data. Occupancy affects the heating and cooling loads, lighting on/off/dimming status. Thus, room usage and occupancy behaviors affect building energy forecasting. However, potentially useful information such as room booking information and occupant behaviors are not properly evaluated or they are ignored.

To address the above problems in the prior art, the current invention incorporates a new method of calculating occupancy energy profile (OEP) that can then be used to optimize building energy. The main novelty of this invention includes:
A new method of calculating OEPs. This metric provides energy usage and cost breakdown for the devices an occupant utilizes.
A method of detecting and verifying an occupant's location is proposed. The method uses a multiple signal strength and clustering method. The location is also verified using occupancy data and any connected device(s).
New methods of optimizing space usage; lighting performance and room scheduling are employed. The building energy performance is evaluated from the collective OEPs. This will also improve the building energy prediction performance.

In incorporating the methods noted above, the current invention includes the following:
A device data table is proposed to log energy consumption and usage information of devices such as luminaires and HVAC units.
Locations of occupants in building are estimated using signal strength or VLC technology. Benchmark signals at key locations are stored into a lookup table. When a new signal is received, it is mapped to the benchmark point by using a classification method as discussed below.
After an occupant's location is determined, the personal and shared devices are registered into the device data table. The energy consumption of devices are logged, and an occupancy energy profile can be calculated.
By collecting OEPs, the space utilization, lighting and HVAC performance parameters can be evaluated and optimized. In particular, the building's Building Management System can then use this OEP to generating an optimized space usage actuation plan for at least parts of the building's lighting system and an optimized room scheduling system; and thereafter implement the optimized space usage actuation plan.

For a better understanding of exemplary embodiments and to show how the same may be carried into effect, reference is made to the accompanying drawings. It is stressed that the particulars shown are by way of example only and for purposes of illustrative discussion of the preferred embodiments of the present disclosure, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

### BRIEF DESCRIPTION OF THE DRAWINGS

FIG. 1 depicts a flow chart illustrating the steps according to an embodiment of the present invention of estimating an individual's OEP and utilizing this information in building management functions.

FIG. 2 depicts a flow chart illustrating the steps of estimating a user's occupancy location according to an embodiment of the present invention.

FIG. 3 depicts a flow chart illustrating the steps of verifying a user's occupancy location according to an embodiment of the present invention.

FIG. 4 depicts a flow chart illustrating the steps of calculating personal and shared device energy consumption according to an embodiment of the present invention.

FIG. 5 depicts an example of calculating distance based weighting of shared devices according to an embodiment of the present invention.

FIG. 6 is a schematic block diagram of a building control system according to an embodiment of the invention.

### DETAILED DESCRIPTION OF THE EMBODIMENTS

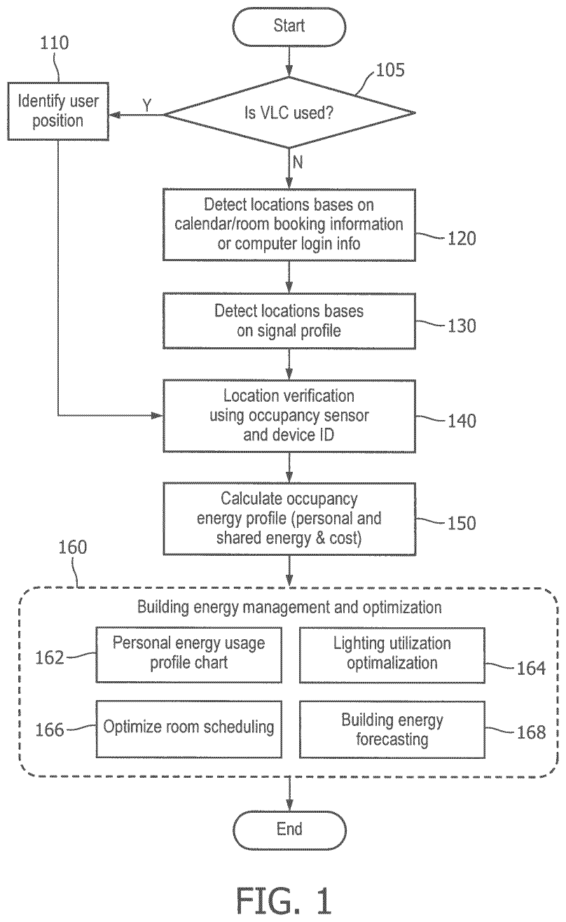

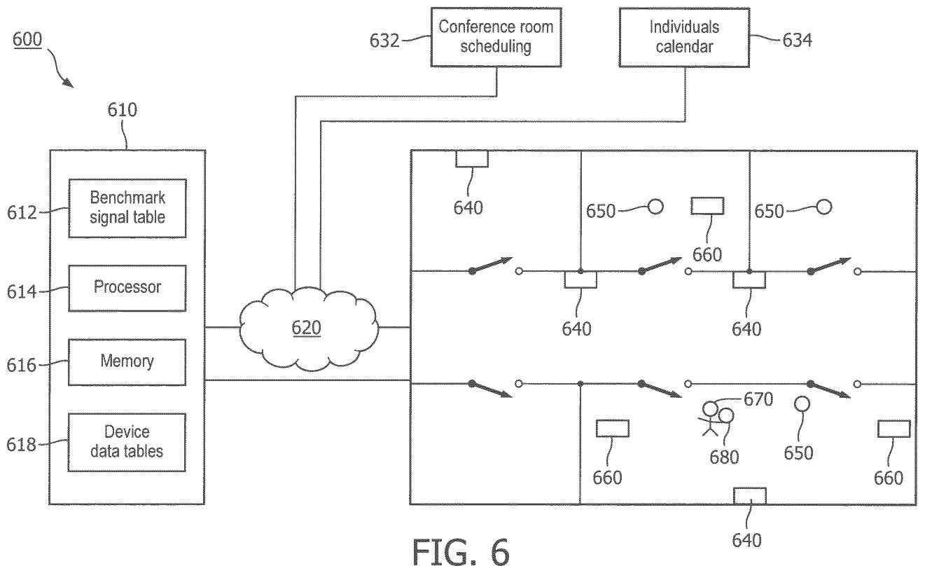

FIG. 1 depicts a flow chart showing an outline of the overall method for estimating an individual personal profile according to an embodiment of the present invention. The method may be implemented by a system as shown in the schematic block diagram of FIG. 6.

The method of FIG. 1 begins by first identifying the position of the user. In this regard, at step 105 it is determined if Visible Light Communication (VLC) is installed. If VLC (e.g., coded light) is installed, the occupancy location is readily determined at step 110 based on the VLC information—using for example, VLC functionality contained in personal phones or laptops.

If the use of VLC technology is not available, at step 120 the user location is attempted to be made based on calendar/room booking information. Such information is available via commercial software which provides room booking functions. For example, Microsoft Outlook has the function of scheduling meetings to include booking rooms and listing of attendees. Thus, the reservations of conference rooms can be used to predict an occupant's location at the meeting time. However, such online booking information is of little value when a specific meeting room number is not provided, if the meeting location is not specified, or if the user fails to attend the meeting for whatever reason. Other techniques can then be used to estimate a user's location—such as using computer login location/IP address.

At step 130 a user location is also attempted to be determined by using a signal profile. That is, a wearable sensor or personal device serves as a source of location detection. For example, laptops and phones receive signals such as Wi-Fi and Bluetooth and the signal strength relative to fixed, known transmitter locations can be used as an indicator of the possible device location.

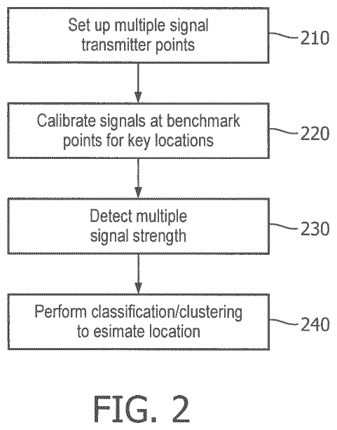

FIG. 2 depicts a flow chart illustrating in greater detail the steps of estimating an occupant's location according to this signal strength analysis method. In particular, FIG. 2 shows how to use multiple signal strengths to detect a device's location. As described below, clustering and classification analysis can be used to estimate the location based on benchmark data.

As illustrated, at step 210 multiple signal transmitter points are established in key locations inside the building space. By way of example, the transmitted signal could be Wi-Fi, Bluetooth or RF. The purpose of using these multiple signals is to provide multiple levels of signal profile so that a signal receiver (e.g., computer/phone) can detect a signal strength vector. The location can then be estimated from the vector. It should be noted that although referenced herein as “transmitters” or “transmitter points,” these transmitters are capable of receiving communication signals as well. Similarly, the device in the possession of the occupant, referred to herein as a “receiver,” has transmission capability as well.

The actual locations of placing the signal transmitters is determined by maximizing variance between detected multiple signal strengths in each room or zone. For example, assume the system of the present invention provides three signal sources: A, B, and C. The locations of the three transmitters are determined by maximizing the ratio difference of the three signals. In particular, the following optimization can be used to calculate the occupant's location:
Max (var(ƒᵢ(Lⱼ))) where Lⱼ=signal strength of j at location i; ƒᵢ=function with parameter of signal strengths Lⱼ at location I; and Var=variance of ƒᵢ. The function f can be selected from a number of options, for example, ƒᵢ may be a linear function and output is linear conversion of signal strength Lⱼ, or ƒᵢ may also be variance or deviation of Lⱼ.

In Step 220, the signal strengths in different rooms/zones or key locations are measured. The purpose of this measurement is to provide benchmark signals to be used to detect the locations as well as to obtain training data sets for classification and clustering analysis.

In Step 230 a signal strength vector is detected and recorded when a receiver device (e.g., a laptop) changes its location. In one embodiment of the invention, the receiver comprises an APP tool which connects the device to one or more of the transmitters, receives signals from the transmitters, and communicates the strength of the received signal back to the respective transmitters. The transmitters then transmit this information to a system server, which derives a signal vector for each receiver. The signal vector can be represented as R=ƒ(s₁, s₂, . . . , s₃) where sᵢ=signal strength received from a transmitter i.

As depicted in step 240, after the data are collected, classification/clustering is performed to detect the possible device's location. Such clustering/classification methods are well known in the prior art and include, by way of example, the use of decision trees, SVMs (support vector machines), random forest trees, or neural networks to estimate which signal vector belongs to which location. Further, to provide a better estimation, time series signal data are collected during the device's movement. The time series data can help to provide a more accurate classification/clustering, and validate the previous classification/clustering results. This is because time serial data contain signal trend information (e.g., a particular signal strength increases faster than another) and moving continuity (e.g., a device moving from a location A has to pass location A's adjacent locations, and during this moving the signal strength is recorded continuously).

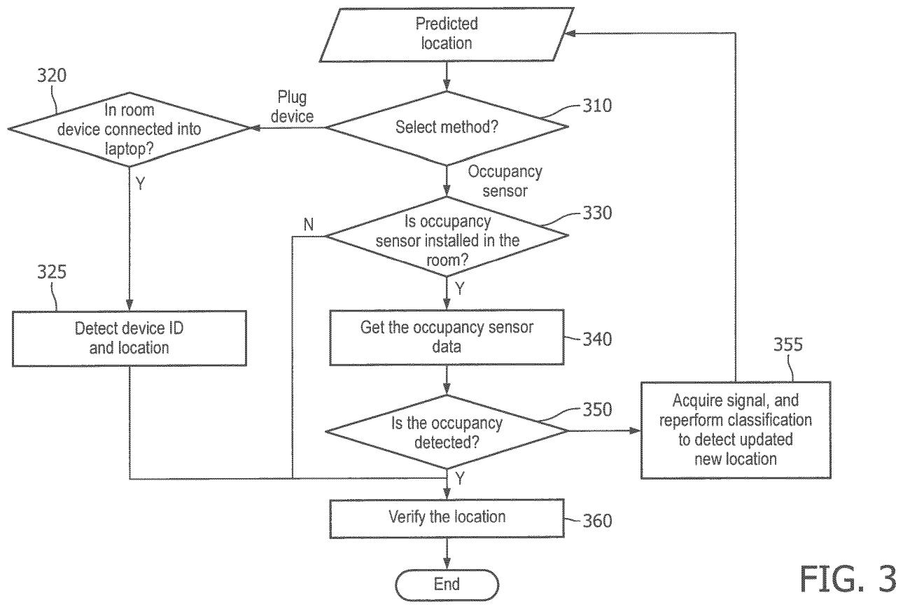

Returning to FIG. 1 and step 140 in particular, the estimated device location is verified using any available occupancy sensor or device ID. That is, the above described predicted location may be inaccurate due to change in signal strength or classification error, and accordingly, verification is desired. FIG. 3 depicts a flow chart illustrating the steps of verifying a user's occupancy location according to an embodiment of the present invention.

At step 310 a decision is made as to which of two methods is to be employed. The first one (depicted as step 320) employs detecting a room device (e.g., power outlet, projector) that is connected to the user's personal device (e.g., personal laptop). If so, the room device ID is used to estimate the personal device location (step 325) which can then be used to verify the user's location (step 360). The second method relates to whether or not an occupancy sensor is installed in the room (as depicted in step 330). If so, occupancy sensor data is obtained (step 340) and a determination is made whether the room is occupied (step 350). For example, if an occupancy sensor is installed in the predicted location (e.g., a conference room), the occupancy sensor detects whether this space is occupied or not. If there is no one in the room, the predicted location is incorrect. In such a case, the system can re-acquire signals and re-perform classification to select another possible location (step 355). If the room is occupied, while not conclusive, this result at least substantiates that the individual can be present at the predicted location (step 360).

Returning again to FIG. 1, and step 150 in particular, personal and shared device energy consumption is now calculated to obtain an occupancy energy profile (OEP). As noted above, the OEP is defined as the energy consumption profile of each occupant in a building. The OEP includes building energy consumption due to personal and shared devices for each occupant. The personal device is defined as devices mainly used by the individual occupant such as personal laptops. The shared device is defined as those jointly used by multiple users.

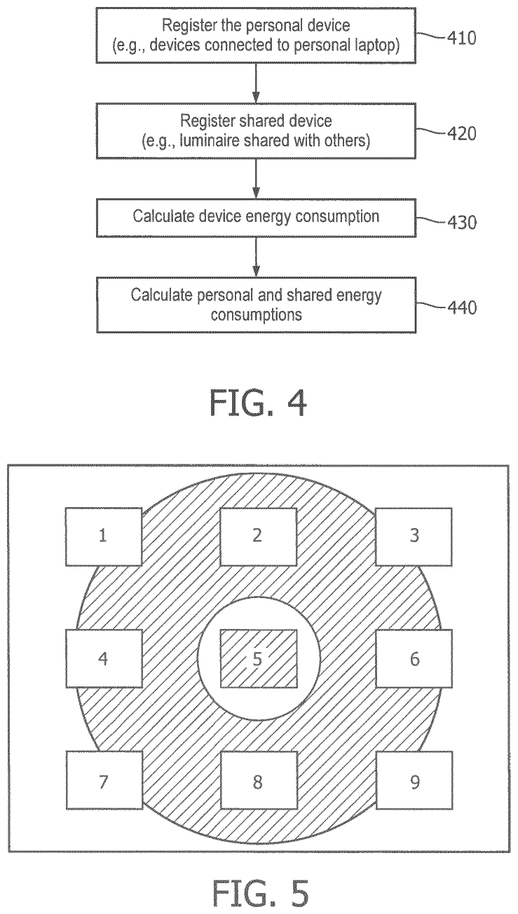

The energy consumed by shared devices needs to be distributed among users. For example, when an occupant sitting in the open plan office, the energy consumed by lighting and HVAC units is shared by occupants inside the office. The steps of identifying personal and shared devices and calculate personal energy profile are shown in FIG. 4.

In Step 410, processor 614 is configured to enable registration an occupant's (e.g. first occupant, second occupant, etc.) personal device into a device table. For example, the registration process may be automatic via the transmitter points 640 in a room/zone or an occupant using an in room/zone user interface or via the personal device's interface, such as a smart device application. A device table may list all the possible devices, user's locations, and the device start and stop times at those locations, which is also known hereinafter as “use time”. For instance, an example of a device table is shown in Table 1 below:

| | | | Device 1 - | Device 2 - | Device 3 - |
|---|---|---|---|---|---|
| Time stamp | Location | User Id | personal | sharable | personal |
| 12:20 | A | 001 | Register | | |
| 12:25 | A | 002 | | Register | |
| 12:35 | A | 001 | Unregister | Register | |
| 13:20 | A | 001 | | Unregister | Register |

As illustrated in this exemplary table, at location A, User 001 starts to use Device 1 at 12:20. The user stops using device 1 and starts to use device 2 at 12:35.

In step 420 of FIG. 4, similar to personal devices, the shared devices are registered. When there are shared devices in a room/zone such as lighting, HVAC, etc., all occupants of the room/zone are registered. For example, all the users/occupants in a room share lighting energy, thus are registered. As noted above, the registration may be automatic, conducted by one of the occupants or by each individually. Further by way of example, in Table 1 Device 2 is sharable. Thus, when first User 001 and second User 002 are in the same location, when User 001 user/occupant is registered into the device, other users/occupants will register into the device automatically.

In Step 430, once the device is registered, a time log is started and stored in memory 614. The time log is used to calculate device usage time. Once the device is unregistered, the log stops, and the energy consumption and cost for this device is calculated.

In Step 440, the personal and shared energy consumption is calculated. The OEP can be calculated using different methods. For example, a simple method can be calculated based on the following equation:

E=E_{P}+E_{S}=E_{P}+E_{d}/N

### Where:

E_{P}=energy consumption by an individual's personal devices;
E_{S}=energy consumption by an individual related to his use of shared devices;
E_{d}=energy consumption by the shared devices.
N=the number of persons sharing the devices. In various embodiments, N can be determined by multiple ways. For example, based on the number of attendees, or based on methods discussed above with respect to FIGS. 2 and 3.

In another embodiment of the invention, calculating OEP is performed in part by utilizing localization of the occupant with respect to a shared device. That is, for example, to specifically calculate how much light energy is used for an occupant. Once the occupant location is identified, the lighting energy consumed by this occupant can be refined using the following equation:

E=E_{P}+E_{S}=E_{P}+(E_{SL}+E_{SD})=E_{P}+(ΣwᵢEᵢ)+E_{SD}

Where:

E_{P}=energy consumption from personal devices.
E_{SL}=energy consumption from lighting energy mainly shared by this occupant.
E_{SD}=energy consumption from shared devices except lighting;
wᵢ=weight of lighting device i;
Eᵢ=energy consumption from lighting device i.

In the above equation, the weight w is calculated using distance-based weight calculations. An exemplary embodiment is provided with the example illustrated in FIG. 5. In this example, there are nine luminaires and an occupant is under luminaire #5. The weight matrix of lighting energy consumption for all the nine luminaires is calculated based on the approximated distance. For example, luminaires in the small circle have a higher weight than luminaires in the large circles. Among the eight luminaire within the large circle, luminaires #2, #4, #6 and #8 have higher weight than the other four luminaires.

Returning again to FIG. 1, occupant locations and energy profiles can now be used for building energy management (step 160) to include, lighting control optimization (step 164), space optimization (Step 166) and building energy forecasting (step 168). Some examples are provided below:

The occupancy energy profile can allow personal data tracking (step 162). For example,

1) Visualize energy footprint and activity.
2) Visualize occupancy tracking and visualize the occupancy location.
3) Analyze time and energy spent on each device (e.g., laptops, luminaires, HVAC or printers).
4) Visualize spatial distribution of energy consumption using heatmap.

The occupancy energy profile can be also used for space optimization and meeting room scheduling (step 166).

### 1) Space Performance Ranking

Occupancy energy profile shows energy consumed in a space. The space can be ranked in terms of energy consumed by devices and time occupied by users. For example, when daylight control is used, the occupancy energy profile may show a lower usage pattern. When the room is shared by multiple users, the lighting energy profile becomes lower. Thus a space with daylight controlled lighting system may have a higher ranking score when the occupancy energy profile shows a low lighting energy usage.

### 2) Space Utilization Rate

It is calculated using equation: R=ΣP/E, where P=personal energy consumption; E=total energy consumption in this room. When the rate is very low, it implies that the space is under utilization. Similarly, this approach can be used to analyze device utilization.

### 3) Meeting Room Scheduling

A person typically books a meeting room based only upon the availability of the room, or perhaps its location. Occupancy energy profiles can show which person tends to use which room, and which device is used most frequently. If some room frequently used shows a high occupancy energy usage than a less frequently used room, suggestion is provided to the occupant to switch meeting room.

### 4) Equipment Error Detection

The method can be used for room equipment error detection. For example, if a user enters into a conference room and finds some equipment does not work, then they may choose another room. The room switching detected by the system may indicate equipment error inside the room.

Further, in various embodiments of the invention, lighting control parameters and energy performance can be evaluated using the energy profile. By way of example:

### 1) Timeout Optimization

From occupancy pattern and lighting energy information, the current invention can optimize the timeout settings. The timeout can be better optimized than just using occupancy data without knowing the space occupant and occupancy pattern.

### 2) Fault Diagnosis

If the system detects the occupant is in a room, but the occupancy sensor is not triggered, this indicates a possibility of error in the occupancy sensor.

In various embodiments of the invention, the building energy forecasting methods can be improved by using occupancy energy profile data. Previous prior art methods and systems relate to data that is collected mainly based on building or (at best) room level to predict the energy usage. Using personal energy profile, occupancy pattern and behaviors can be predicted with higher accuracy once the personal energy profile is known. Thus, more accurate energy usage can be determined such as a room's the plug load (the energy used by products that are powered by means of an ordinary AC plug) can be estimated.

In a further embodiment of the invention, implementation of the above methods can be obtained from an exemplary building control system 600 as depicted in FIG. 6. The exemplary building management system illustrated includes a processing unit 610 including a processor 614, a memory 616, a benchmark signal table 612, and one or more device data tables 618. The building management system 600 also includes a network (e.g., a local area network) 620 that is connected to a plurality of devices located in designated rooms, offices, hallways and/or shared areas. Network 620 may be a wireless network or a wired network or a combination of wired and wireless networks. For example, the network 620 may be one of, or a combination of, wired, wireless, WiFi and 3G (or 4G) networks. The processing unit 610 may be a dedicated computer system or may be a slave computer that is further connected to one or more additional computer systems via an additional network (not illustrated).

The plurality of devices located in designated rooms, offices, hallways and/or shared areas comprise transmitter points 640 used in estimating the location of an occupant 670 of the building and room occupancy sensors 650. As depicted, it is not necessary for transmitter points 640 to be located in each room as the invention. Rather, the placement of transmitter points is determined utilizing the expression Max (var(ƒᵢ(Lⱼ))) as discussed above. As also described above with respect to various embodiments of the invention, both the transmitter points 640 and personal devices 680 in the possession of the occupant 670 have both receiving and transmitting capability which permit estimating the location of the occupant by the building management system.

The building management system is employed, as described above in the method embodiments of the invention, to determine the location of an occupant 670 and the energy usage of one or more personal devices 680 and shared devices (e.g., items 660) that are in use in that determined location. These shared devices comprise both devices that are fixed to the room such as overhead lights, as well as moveable items that are temporarily in use in the room, such as a projector. The energy usage is determined by the processing unit's use of the device data table(s) 618. That is, the processing unit 610 is capable of attaining an occupancy energy profile for occupant 670 as well as other occupants of the building.

As depicted, processing unit 610 has access via network 620 to system data files such as conference room schedules 632 and individuals' appointment calendars 634. As noted above this information is potentially useful in determining and/or verifying an individual's location in the building.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for estimating an occupancy energy profile in a building management system for at least one occupant of a building having a plurality of rooms/zones and one or light energy consuming devices in the plurality of rooms/zones, the method comprising:
estimating an occupant's location in the plurality of rooms/zones of the building;
registering, in the building management system, the occupant's personal device into a device data table and tracking a use time of the personal device in a room/zone;
registering, in the building management system, the occupant and any other occupants of a room/zone when a shared device is located in the room/zone, into the device data table and tracking a use time of the shared device for at least the occupant;
storing, in a memory of the building management system, the use times for an occupant's personal and shared devices;
in a processor of the building management system
determining energy consumption of the personal and shared devices, wherein the energy consumption of the personal devices is based on the stored use times of the personal device and the energy consumption of the shared devices is based on the stored use times and a distance-based weighting of the occupant to each light energy consuming device in the plurality of room/zones;
generating an energy profile for the occupant using the energy consumption, and a space usage actuation plan for at least parts of the building's lighting system and room scheduling system; and
controlling the one or more energy consuming devices using the energy profile for the occupant.

2. The method of claim 1 wherein the step of estimating an occupant's location comprises using Visible Light Communication functionality.

3. The method of claim 1 wherein the step of estimating an occupant's location comprises utilizing calendar and/or room booking information.

4. The method of claim 1 wherein the step of estimating an occupant's location comprises:
establishing a plurality of multiple signal transmitter points at various locations in the building;
storing in a lookup table, benchmark signals associated with each of the various locations;
receiving by a device in the occupant's possession, signals emitted from a plurality of the transmitter points;
transmitting by the device the strength of the received signal back to the transmitter point which sent the signal;
communicating by the transmitter point the strength of the received signal to a system server to thereby obtain a signal strength vector pertaining to each of the signals received by the device;
performing classification/clustering of the signal strength vectors to estimate the location of the occupant.

5. The method of claim 4 wherein the device in the occupant's possession is selected from the group consisting of: a wearable sensor, a laptop, a cell phone, a Wi-Fi device, a Bluetooth device, an RF device, and combinations thereof.

6. The method of claim 1, further comprising the step of verifying the estimated location of the occupant before the calculating step occurs.

7. The method of claim 6 wherein the verifying step comprises:
identifying at least one room device that is connected to the device in the occupant's possession; and,
using an ID of the room device to establish the location.

8. The method of claim 6 wherein the verifying step comprises:
determining if the estimated location has an occupancy sensor installed;
obtaining occupancy sensor data; and,
determining if the estimated location is occupied.

9. The method of claim 1 wherein the step of registering the occupant's personal and shared devices into a device data table comprises:
listing the location of the occupant and on and off times for all devices in the possession of the occupant;
listing all shared devices at the location that are used by the occupant and on and off times for occupant's usage of the shared devices.

10. The method of claim 1 wherein the step of calculating an energy profile comprises:
computing energy consumption and cost of occupant's personal devices;
deriving energy consumption and cost of shared devices, wherein said deriving comprises using a weighting factor when the occupant's proximity to a shared device provides him with greater benefit of the shared device.

11. A method of providing building management functions to a building, using one or more of the occupancy energy profiles of claim 1; said building management functions being selected from the group consisting of lighting control optimization, HVAC optimization, space optimization, meeting room scheduling, personal data tracking, equipment error detection, maintenance functions, building energy forecasting, and combinations thereof.

12. A system for providing an estimate of an occupancy energy profile for at least one occupant of a building having a plurality of rooms/zones and one or light energy consuming devices in the plurality of rooms/zones, the system comprising:
transmitter points for use in attaining signal strength vectors related to a device (680) in the possession of the occupant;
a processing unit for analyzing the signal strength vectors to estimate an occupant's location in the building; and
a memory for storing a device data table, wherein the processing unit is configured to enable the occupant to register into the device data table the occupant's personal devices and track a use time of the personal device in a room/zone, and register the occupant and any other occupants of a room/zone when a shared device is located in the room/zone, into the device data table and track a use time of the shared device for at least the occupant;
wherein the processing unit determines energy consumption of the personal and shared devices, wherein the energy consumption of the personal devices is based on the stored use times and the energy consumption of the shared devices is based on the stored use times and a distance-based weighting of the occupant to each light energy consuming device in the plurality of room/zones, generates an energy profile for the occupant using the energy consumption and controls the one or more energy consuming devices using the energy profile for the occupant.

13. The system of claim 12 further comprising one or more room occupancy sensors for use in verifying the estimated occupant's location.

14. The system of claim 12 further comprising building administration data tables for use in verifying the estimated occupant's location; said administration data tables consisting of conference room scheduling data, calendars of individual's scheduled activities, and combinations thereof.

15. A system for providing building management functions to a building, said system comprising:
a processor for using one or more of the calculated occupancy energy profiles of claim 14 to perform building management functions, said building management functions selected from the group consisting of lighting control optimization, HVAC optimization, space optimization, meeting room scheduling, personal data tracking, equipment error detection, maintenance functions, building energy forecasting, and combinations thereof.
